(19) United States
(12) Patent Application Publication
(10) Pub. No.: US 2003/0107603 A1
(43) Pub. Date: Jun. 12, 2003

(54) Scroll notification system and method

(75) Inventor: Edward O. Clapper, Tempe, AZ (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 10/020,422

(22) Filed: Dec. 12, 2001

(51) Int. Cl. G09G 5/00

(52) U.S. Cl. 345/784

(57) ABSTRACT

If information in a display window is scrollable by a user-controllable element, a notification is generated to the device user. The scrollability notification function can be implemented in many different ways and in a variety of equipment, including an Internet appliance or a personal computer. In one embodiment, when a scrollable object is detected in a window on which the device user is focusing, a vertical and/or horizontal scroll wheel is illuminated to indicate that the window is scrollable in the corresponding direction(s). The scrollability notification function can be implemented in different ways, such as through the particular software application, through the operating system, or through a custom software module. A computer, a computer network, and methods for providing a scrollability notification to a computer user are also described.

### TECHNICAL FIELD OF THE INVENTION

The present invention relates generally to the field of data processing and, more particularly, to improved systems and methods to indicate that information on a display can be scrolled.

### BACKGROUND OF THE INVENTION

When information is displayed to a device user on a display, if the document containing the information being displayed exceeds the horizontal dimension of the display or of a display window, the device user must scroll in a horizontal direction to view the entire width of the document. In horizontal scrolling, portions of the document width are viewed sequentially, but the entire document width does not fit within the horizontal confines of the display or display window.

Similarly, if the document containing the information being displayed exceeds the vertical dimension of the display or of a display window, the device user must scroll in a vertical direction to view the entire length of the document. In vertical scrolling, portions of the document height are viewed sequentially, but the entire document height does not fit within the vertical confines of the display or display window.

It is well known that prior computer devices, including displays, enable device users to scroll through documents in the horizontal and/or vertical directions. However, as computer devices become increasingly ubiquitous, unsophisticated device users or device users who are unfamiliar with a particular computer device may be unaware that a document is scrollable. As a result, such device users may miss seeing a portion of the information being displayed.

For the reasons stated above, and for other reasons stated below which will become apparent to those skilled in the art upon reading and understanding the present specification, there is a significant need in the art for systems and methods that will alert a device user that information on a display is scrollable.

### BRIEF DESCRIPTION OF THE DRAWINGS

FIG. 1 illustrates a block diagram of a computing device, and of an optional computer network comprising remote computing devices, that provide notification of scrollability, in accordance with one embodiment of the invention;

FIG. 2 illustrates a self-contained computing device that provides notification of scrollability, in accordance with one embodiment of the invention;

FIG. 3 illustrates two display windows of a computing device that provides notification of scrollability, showing user focus on a non-scrollable display window;

FIG. 4 illustrates two display windows of a computing device that provides notification of scrollability, showing user focus on a scrollable display window and corresponding notification of scrollability, in accordance with one embodiment of the invention; and

FIGS. 5A, 5B, and 5C together illustrate a flow diagram of methods of providing notification of scrollability, which methods are implemented in a computer system, in a computer network, or in a computational machine operating under control of instructions residing on a machine-accessible medium, in accordance with various embodiments of the invention.

### DETAILED DESCRIPTION OF EMBODIMENTS OF THE INVENTION

In the following detailed description of embodiments of the invention, reference is made to the accompanying drawings which form a part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, procedural, mechanical, and electrical changes may be made without departing from the spirit and scope of the present inventions. The following detailed description is, therefore, not to be taken in a limiting sense, and the scope of the present invention is defined only by the appended claims.

The present invention provides for window scrollability notification to a user of a computing device and associated methods. Various embodiments are illustrated and described herein. In one embodiment, implemented in an Internet appliance, when a scrollable object is detected in a window on which the device user is focusing, a vertical and/or horizontal scroll wheel built into the Internet appliance is illuminated to indicate that the window is scrollable in the corresponding direction(s). In another embodiment, implemented on a personal computer, when the device user focuses on a scrollable window, a vertical and/or horizontal scroll wheel of a pointing device is illuminated to indicate that the window of focus is scrollable in the corresponding direction(s). The scrollability notification function can be implemented in different ways, such as through the particular software application, through the operating system, or through a custom software module. A computer, a computer network, and methods for providing a scrollability notification to a computer user are also described.

The term “scroll”, as used herein, means to move displayed information horizontally and/or vertically within a display window in order to view all of the displayed information, because the displayed information is otherwise truncated in the horizontal and/or vertical directions.

The improved scrolling methods and apparatus disclosed herein are inexpensive and adaptable, and they can significantly increase the commercial value of computer software and computer systems, such as Internet appliances, personal computers, and the like, in which they are featured.

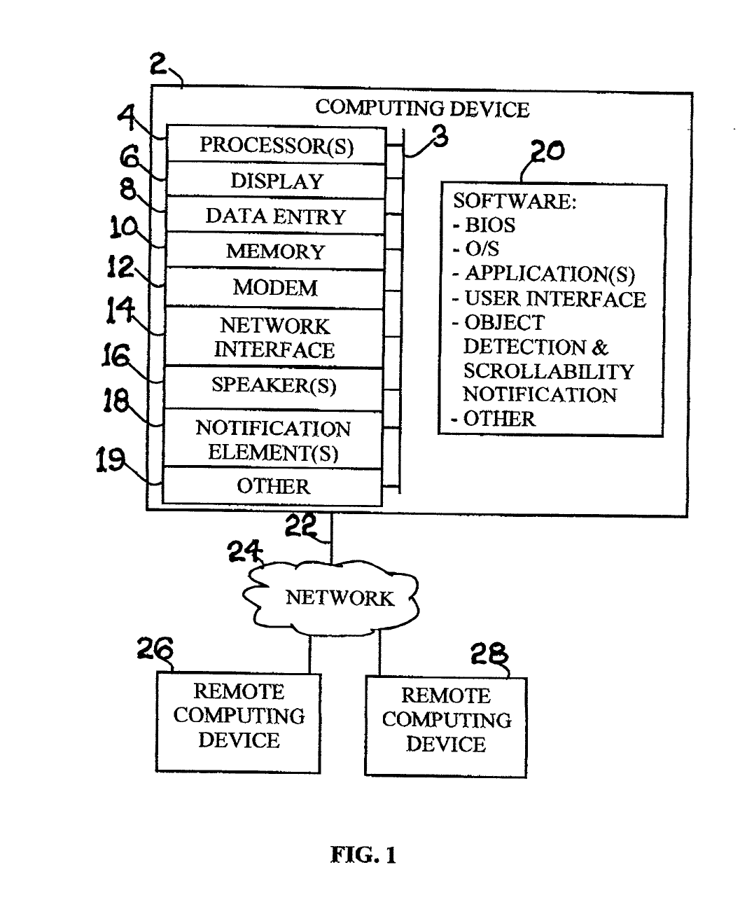

FIG. 1 illustrates a block diagram of a computing device 2, and of an optional computer network 24 comprising remote computing devices 26 and 28, that provide notification of scrollability, in accordance with one embodiment of the invention.

FIG. 1 and the following discussion are intended to provide a brief, general description of a suitable computing environment in which certain aspects of the illustrated invention may be implemented. An exemplary system to provide scrollability notification to a computer user includes a machine or computing device 2 having system bus 3. Typically, attached to bus 3 are one or more processors 4, a display 6, and one or more data entry elements 8 such as a keyboard, mouse, trackball, joy stick, touch-sensitive screen, or the like. Also attached to bus 3 is a memory 10, which can include any suitable memory device(s) like read only memory (ROM); random access memory (RAM); hard drive; removable media drive for handling compact disks (CDs), digital video disks (DVDs), diskettes, magnetic tape cartridges, and other types of data storage; or the like. Additional elements can also be attached to bus 3 such as a modem 12, a network interface unit 14, one or more speakers 16, and other suitable devices 19.

Also attached to bus 3 are one or more user notification elements 18. As will be explained in greater detail below, user notification elements 18 can be any structure to generate a human perceivable stimulus.

“Human perceivable stimulus”, as used herein, means anything that has a perceptible effect on the human sense of sight, hearing, or touch. Examples include, but are not limited to, visible indicators, audible indicators, and vibratory indicators.

“Processor”, as used herein, means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit. The term also includes embedded controllers, such as Generic or Programmable Logic Devices or Arrays, Application Specific Integrated Circuits, single-chip computers, smart cards, and the like.

“Suitable”, as used herein, means having characteristics that are sufficient to produce the desired result(s). Suitability for the intended purpose can be determined by one of ordinary skill in the art using only routine experimentation.

Computing device 2 can optionally operate in a networked environment using a physical and/or a logical connection 22 to one or more remote computing devices or systems 26 and 28 via wired or wireless network 24. Network 24 can be an intranet; the Internet; a local area network; a wide area network; a cellular, cable, laser, satellite, microwave, “Blue Tooth”, optical, or infrared network; or any other short-range or long-range wired or wireless network.

The invention may be implemented in conjunction with program modules, including functions, procedures, data structures, application programs, etc. for performing tasks, or defining abstract data types or low-level hardware contexts. Program modules may be stored in memory 10 and associated storage media, e.g., hard-drives, floppy-disks, optical storage, magnetic cassettes, tapes, flash memory cards, memory sticks, digital video disks, chemical storage, and/or biological storage. Program modules may be delivered over transmission environments, including network 24, in the form of packets, serial data, parallel data, propagated signals, etc. Program modules may be used in a compressed or encrypted format, and they may be used in a distributed environment and stored in local and/or remote memory, for access by single and multi-processor machines, portable computers, handheld devices (e.g., Personal Digital Assistants (PDAs)), cellular telephones, pagers, personal entertainment devices (e.g. digital music players), one-way or two-way radios, or the like.

Thus, for example, with respect to the illustrated embodiments, assuming that computing device 2 provides scrollability notification to a computer user, then one or both of remote computing devices 26 and 28 may be configured like computing device 2, and they can include many or all of the elements discussed for computing device 2. One or both of remote computing devices 26 and 28 could also be a server comprising software for providing scrollability notifications to computer users of computing device 2 and other computing devices coupled to network 24. It should also be appreciated that while devices 2, 26, and 28 are typically separate communicatively-coupled components they could be embodied within a single device.

Computing device 2 can be any type of computer or computer-based display for displaying information, such as an Internet appliance; a personal computer; a pay-for-use computer located in an Internet cafe, hotel, or the like; an electronic book or other device for displaying information; a pager; a cellular telephone; a palm-top computer; a notebook computer; a laptop computer; or the like.

Devices 2, 26, and 28 can further comprise a plurality of types of software programs. For example, computing device 2 can comprise software 20 that includes a basic input/output system (BIOS), operating system (O/S) software, one or more software applications, a user interface, software to detect scrollable objects and to provide scrollability notification, and any other types of software as required to perform the operational requirements of computing device 2.

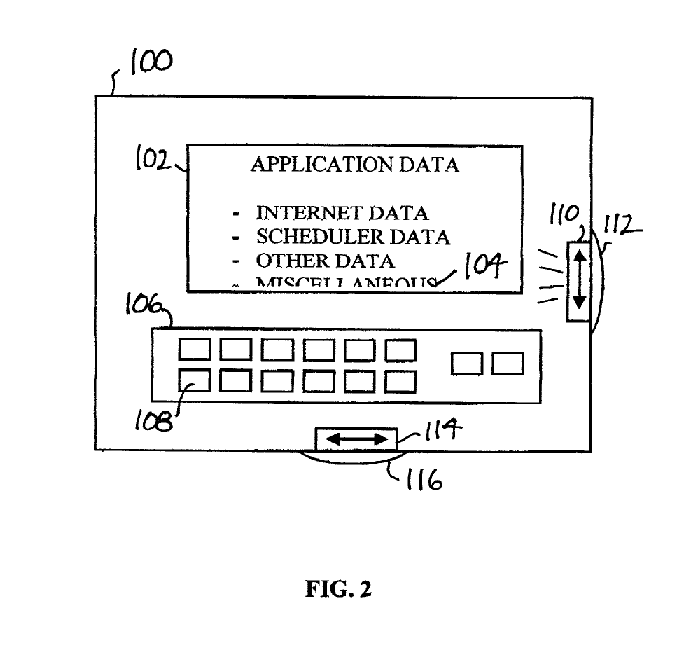

FIG. 2 illustrates a self-contained computing device 100 that provides notification of scrollability, in accordance with one embodiment of the invention. Computing device 100 comprises a display 102 in which information is displayed to a user of computing device 100. Computing device 100 comprises various user interface elements such as a keyboard 106 having one or more keys 108. Computing device 100 additionally comprises a vertical scroll wheel 112 and a horizontal scroll wheel 116.

Associated with and proximate to vertical scroll wheel 112 is a notification element 110. Likewise, associated with and proximate to horizontal scroll wheel 116 is a notification element 114. In the embodiment illustrated in FIG. 2, notification elements 110 and 114 are legends that can each be independently illuminated by a respective light-emitting diode or light bulb, for example.

In the example illustrated in FIG. 2, a portion of information 104 being displayed in display 102 is cut off in the vertical direction. As a result, an indication is provided to the device user that information 104 being displayed in display 102 is scrollable in the vertical direction, by illuminating notification element 110. The device user could accordingly use scroll wheel 112 to scroll the information in the vertical direction.

In this example, it is assumed that the width of information being displayed in display 102 does not exceed the width of display 102, so no notification is provided as to horizontal scrollability, as by illuminating notification element 114. However, if the width of information were greater than the width of display 102, then notification element 114 would have also been illuminated to alert the device user that horizontal scrolling could be performed using scroll wheel 116.

Many other types of notification elements are possible. These include, but are not limited to, activation of a light (e.g. by turning on a light associated with scrollability in a particular direction, or selectively turning on one of multiple lights associated with scrollability in a respective one of multiple directions), a change in light intensity (e.g. by dimming or heightening one or more lights associated with corresponding scrolling directions), a change in light color (e.g. indicating scrollability via a green light and non-scrollability via a red light), a change in light location (e.g. turning off one light illuminating a “No Scroll” legend and turning on another light illuminating a “Scroll” legend), a change in a light blinking pattern (e.g. a slow blink pattern to indicate non-scrollability and a fast blink pattern to indicate scrollability), activation of a legend (as in the example shown in FIG. 2), a change in a legend (e.g. a blinking light to indicate scrollability and a steady light to indicate non-scrollability), activation of a sound (e.g. initiation of a tone to indicate scrollability and silence to indicate no scrollability), a change in a sound (e.g. a first pitch and/or pulse pattern to indicate scrollability and a second pitch and/or pulse pattern to indicate non-scrollability, activation of a physical movement (a vibration to indicate scrollability), and a change in a physical movement (e.g. a first type of movement of some portion of the computing device to indicate scrollability and a second type of movement to indicate non-scrollability).

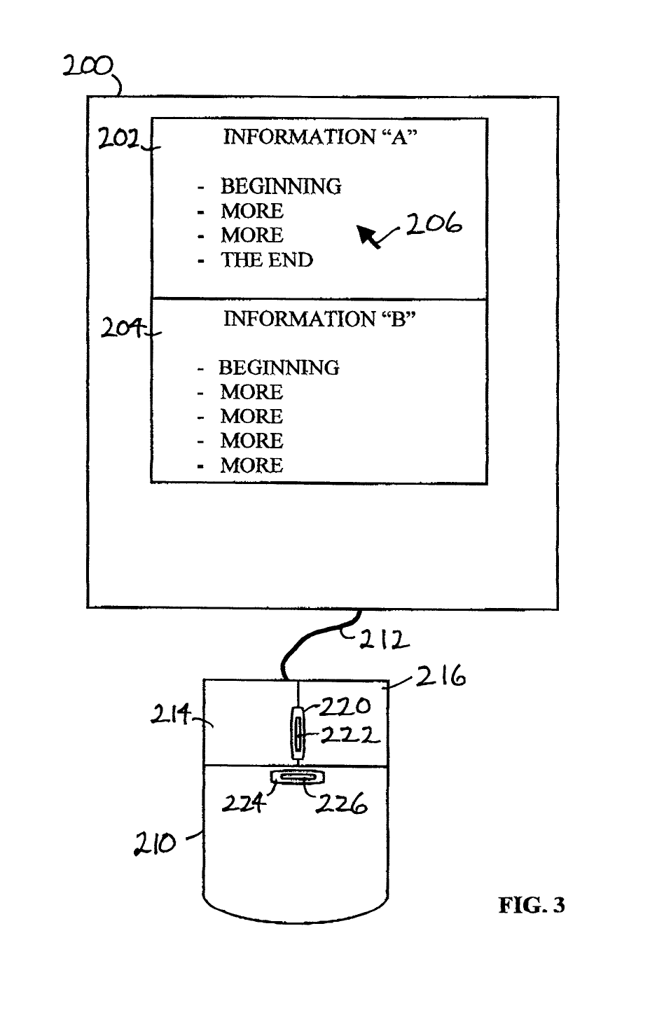

FIG. 3 illustrates two display windows 202 and 204 of a computing device 200 that provides notification of scrollability, showing current user focus on a non-scrollable display window 202. Display window 202 is non-scrollable, because none of the information displayed in window 202 is truncated in either the vertical or horizontal directions.

In the embodiment illustrated, computing device 200 comprises a mouse 210 coupled via cord 212. Mouse 210 comprises a left-hand button 214 and a right-hand button 216. Mouse 210 also comprises a vertical scroll wheel 222 with a corresponding vertical scrollability light 220. Mouse 210 further comprises a horizontal scroll wheel 226 with a corresponding horizontal scrollability light 224.

In the example shown in FIG. 3, the device user has operated mouse 210 to move cursor 206 within display window 202. The presence of cursor 206 within display window 202 indicates that the device user has “focused” on display window 202. That is, the device user selects display window 202 to be the active window for the purposes of viewing data, entering data, editing data, and so forth. Correspondingly, display window 204 is inactive.

In addition to using a mouse such as mouse 210, a device user can achieve focus on a specific display window by any other suitable user interface element. These include, but are not limited to, any element to move a cursor position on a display. Such elements include pointing devices, keys, buttons, a touch-sensitive screen, or a combination of the foregoing.

As a result of focus being achieved on a specific display window, a focus control signal is generated in a manner well known to those of ordinary skill in the art. The focus control signal can take the form, for example, of a software attribute or status indicator with respect to a video display buffer associated with the specific display window. This focus control signal represents the selection of the specific display window. If the device user focuses on a different display window, a different focus control signal is generated.

In addition to the focus control signal, a scrollability control signal is generated for the selected display window in a manner well known to those of ordinary skill in the art. The scrollability control signal can take the form, for example, of a software attribute or status indicator with respect to a video display buffer associated with the specific display window. This scrollability control signal reflects whether information to be displayed in the specific display window is scrollable or not. If all of the information to be displayed in the selected display window can be viewed within the display window without scrolling, the scrollability control signal is indicates “no scrolling”. However, if scrolling of the information is required in the vertical and/or horizontal directions, the scrollability control signal accordingly indicates “vertical scrolling” and/or “horizontal scrolling”.

When the device user focuses on a specific display window, the corresponding focus control signal for that window gates the value of the scrollability control signal corresponding to the same display window. The present invention utilizes the unique control signal corresponding to the gated scrollability control signal for a selected display window as a basis for switching on the appropriate scrollability indicator(s) to notify the device user if information in the selected display window can be scrolled. One of ordinary skill in the art is capable of writing suitable computer program instructions, for storage on suitable storage media, which when accessed by a processor or other computational machine result in a scrollability notification being generated to the device user, depending in part upon the status of the scrollability control signal as described above.

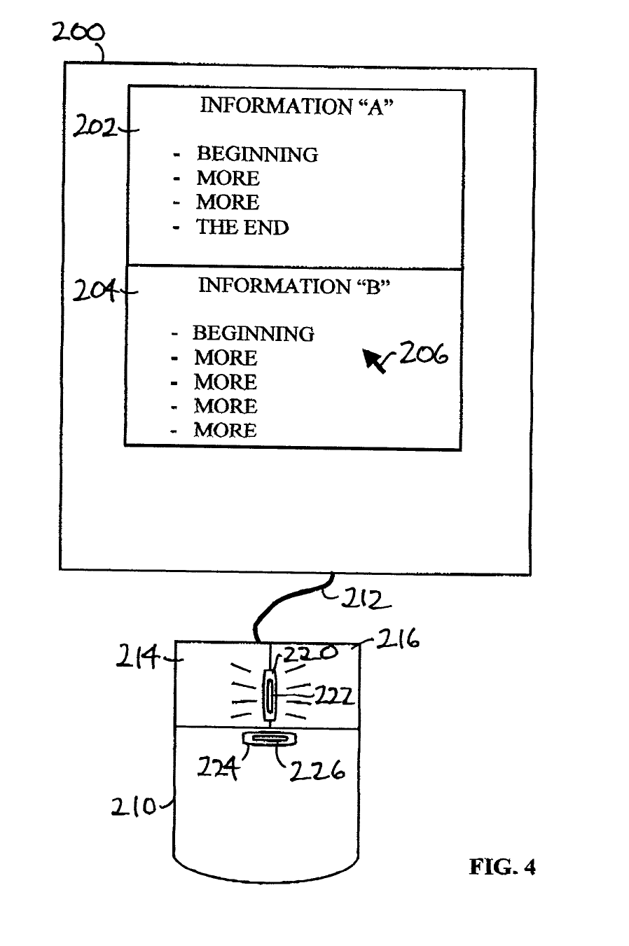

FIG. 4 illustrates two display windows 202 and 204 of a computing device 200 that provides notification of scrollability, showing current user focus on a scrollable display window 204 and corresponding notification of scrollability, in accordance with one embodiment of the invention. Display window 204 is scrollable in the vertical direction, because there is more information in the vertical dimension than can be displayed simultaneously in window 204.

In the example shown in FIG. 4, the device user has operated mouse 210 to move cursor 206 within display window 204. The presence of cursor 206 within display window 204 indicates that the device user has “focused” on display window 204. That is, the device user desires that display window 204 be the active window for the purposes of entering data, editing data, and so forth. Correspondingly, display window 202 is inactive.

Because the device user has focused on display window 204, the display attribute of display window 204 that is set to indicate that display window 204 is scrollable in the vertical dimension is gated by the focus control signal for display window 204 to appropriate software that turns on vertical scrollability light 220 associated with vertical scroll wheel 222. Because, for this example, no scrollability control signal is indicating scrollability in the horizontal dimension, the horizontal scrollability light 224 associated with horizontal scroll wheel 226 is not illuminated.

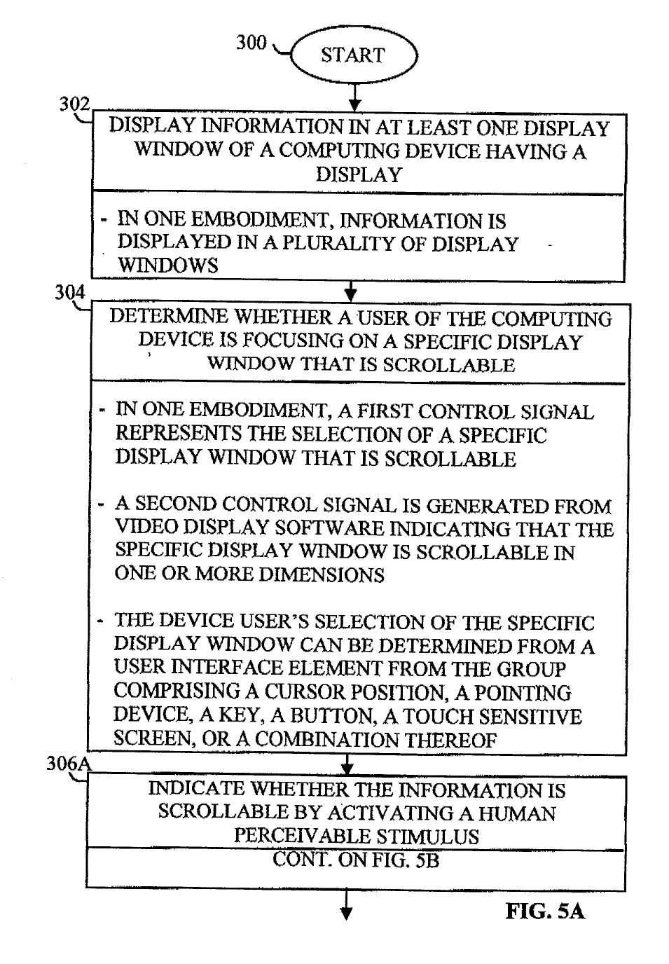

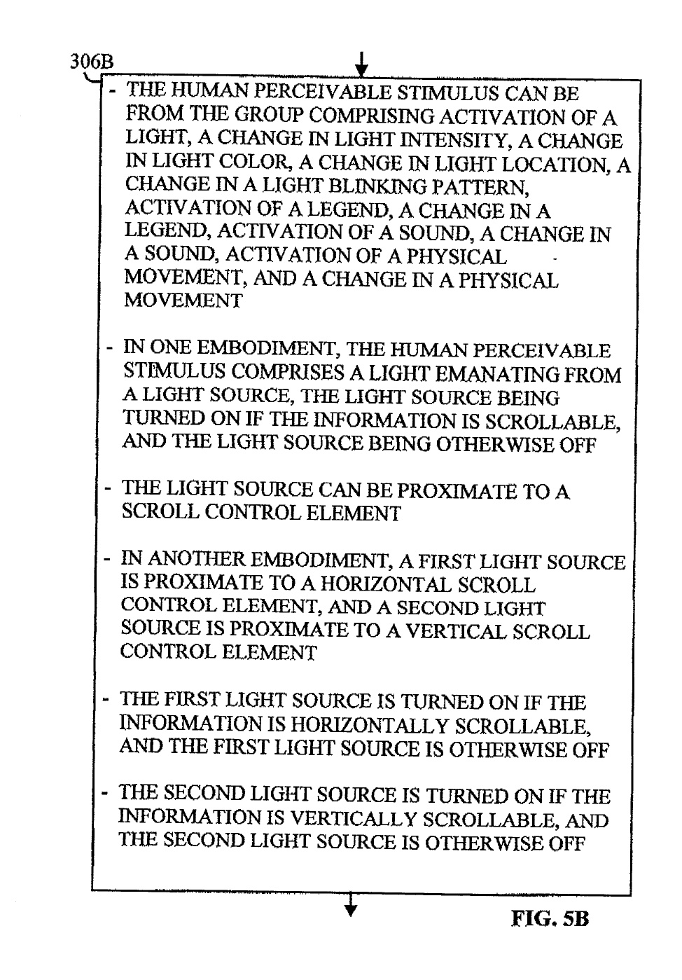

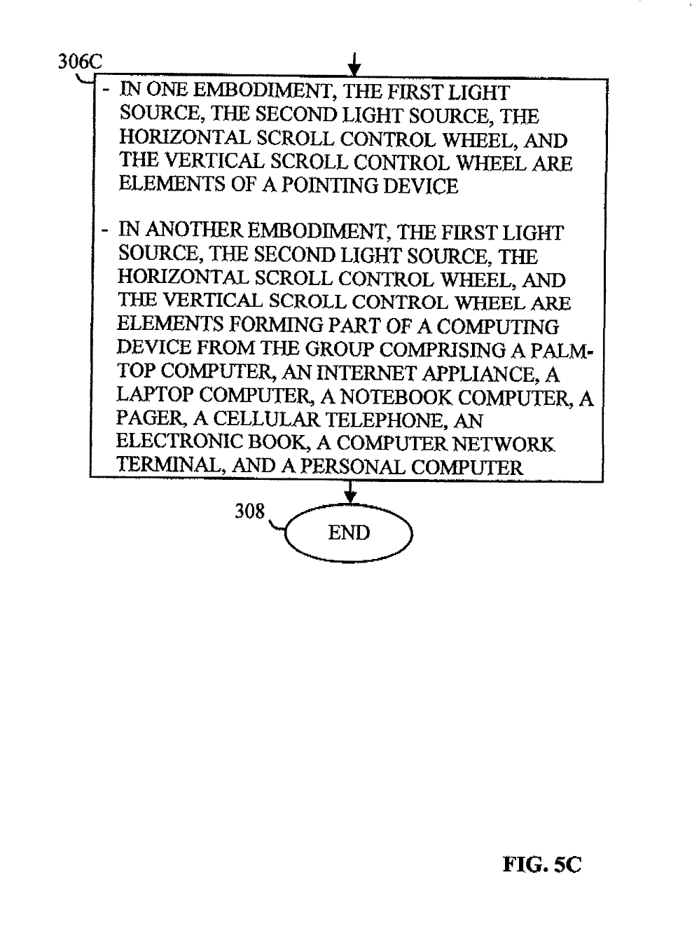

FIGS. 5A, 5B, and 5C together illustrate a flow diagram of methods of providing notification of scrollability, which methods are implemented in a computer system, in a computer network, or in a computational machine operating under control of instructions residing on a machine-accessible medium, in accordance with various embodiments of the invention. The method starts at 300. The method is merely one example of generating a scrollability notification to a user of a computing device. Many other implementations are also possible, as will be apparent to those of ordinary skill in the art.

In 302, information is displayed in at least one display window of a computing device having a display. In one embodiment, information is displayed in a plurality of display windows. For example, in the embodiment illustrated in FIGS. 3 and 4, information is displayed in two different display windows.

In 304, a determination is made whether a user of the computing device is focusing on a specific display window that comprises information that is scrollable in one or more dimensions. In one embodiment, a first control signal is generated representing the selection of a specific display window. A second control signal is generated from video display software indicating that the specific display window is scrollable in one or more dimensions. The device user's selection of the specific display window can be determined from a user interface element from the group comprising a cursor position, a pointing device, a key, a button, a touch-sensitive screen, or a combination of the foregoing.

In 306A, an indication is made whether the information is scrollable. The indication is made by activating a human perceivable stimulus.

Continuing in 306B in FIG. 5B, the human perceivable stimulus can be from the group comprising activation of a light, a change in light intensity, a change in light color, a change in a light location, a change in a light blinking pattern, activation of a legend, a change in a legend, activation of a sound, a change in a sound, activation of a physical movement, and a change in a physical movement.

In one embodiment, the human perceivable stimulus comprises a light emanating from a light source. The light source is turned on if the information is scrollable; otherwise, the light source remains off. The light source can be proximate to a scroll control element.

The term “proximate”, as used herein, means positioned either close to, overlapping with, or within another element. For example, a light source could be placed adjacent to a scroll wheel. Alternatively, a light source could illuminate all or part of the scroll wheel via a suitable mechanism such as a light pipe or optical fiber.

In another embodiment, a first light source is proximate to a horizontal scroll control element, and a second light source is proximate to a vertical scroll control element. The first light source is turned on if the information is horizontally scrollable; otherwise, the first light source remains off. The second light source is turned on if the information is vertically scrollable; otherwise, the second light source remains off.

Continuing in 306C in FIG. 5C, in one embodiment, the first light source, the second light source, the horizontal scroll wheel, and the vertical scroll wheel are elements of a pointing device. As one example, they could form elements of a mouse such as mouse 210 (FIGS. 3 and 4).

Still with reference to FIG. 5C, in another embodiment, the first light source, the second light source, the horizontal scroll wheel, and the vertical scroll wheel are elements forming part of a computer device from the group comprising a palm-top computer, an Internet appliance, a laptop computer, a notebook computer, a pager, a cellular telephone, an electronic book, a computer network terminal, and a personal computer. The method ends at 308.

It should be understood that the operations shown in FIGS. 5A-5C are merely representative and not exclusive, and that many other different alternative operations could be implemented using the concepts taught by the present invention.

The operations described above with respect to the methods illustrated in 5A-5C can be performed in a different order from those described herein. Also, it will be understood that although the methods are described as having an “end”, they typically are continuously performed.

Providing notification of scrollability of information on a display is carried out by suitable instructions in one or more computer programs that are stored in and executed by one or more devices 2, 26, and 28 in FIG. 1. One of ordinary skill in the art is capable of writing suitable instructions to implement the objectives and features of the invention as described herein.

### CONCLUSION

The present invention provides for window scrollability notification to a user of a computing device, as well as associated methods. Various embodiments have been illustrated and described herein. In one embodiment, implemented in an Internet appliance, when a scrollable object is detected in a window on which the device user is focusing, a vertical and/or horizontal scroll wheel built into the Internet appliance is illuminated to indicate that the window is scrollable in the corresponding direction(s). In another embodiment, implemented on a personal computer, when the device user focuses on a scrollable window, a vertical and/or horizontal scroll wheel of a pointing device is illuminated to indicate that the window of focus is scrollable in the corresponding direction(s). The scrollability notification function can be implemented in different ways, such as through the particular software application, through the operating system, or through a custom software module. A computer, a computer network, and methods for providing a scrollability notification to a computer user have also been described.

The herein-described methods and apparatus to facilitate scrolling are inexpensive and adaptable, and they can significantly increase the commercial value of computer software and of computer systems in which they are included.

Other embodiments will be readily apparent to those of ordinary skill in the art. The elements, architecture, and sequence of operations can all be varied to suit particular data security requirements.

The various elements depicted in the drawings are merely representational and are not drawn to scale. Certain proportions thereof may be exaggerated, while others may be minimized. The drawings are intended to illustrate various implementations of the invention, which can be understood and appropriately carried out by those of ordinary skill in the art.

Having described and illustrated the principles of the invention with reference to illustrated embodiments, it will be recognized that the illustrated embodiments can be modified in arrangement and detail without departing from such principles. And, though the foregoing discussion has focused on particular embodiments, other configurations are contemplated. In particular, even though expressions such as “in one embodiment”, “in another embodiment”, or the like are used herein, these phrases are meant to generally reference embodiment possibilities, and they are not intended to limit the invention to particular embodiment configurations. As used herein, these terms may reference the same or different embodiments that are combinable into other embodiments.

Consequently, in view of the wide variety of permutations to the embodiments described herein, this detailed description is intended to be illustrative only, and it should not be taken as limiting the scope of the invention.

Although specific embodiments have been illustrated and described herein, it will be appreciated by those of ordinary skill in the art that any arrangement or process that is calculated to achieve the same purpose may be substituted for the specific embodiments shown. This application is intended to cover any adaptations or variations of the present invention. Therefore, it is manifestly intended that this invention be limited only by the claims and the equivalents thereof.

What is claimed is:

1. A method comprising:
displaying information in a display window of a computing device; and
indicating whether the information is scrollable by activating a human perceivable stimulus.

2. The method recited in claim 1 wherein, in indicating, the human perceivable stimulus is from the group comprising a light, a sound, and a physical movement.

3. The method recited in claim 1 wherein, in indicating, the human perceivable stimulus is from the group comprising activation of a light, a change in light intensity, a change in light color, a change in light location, a change in a light blinking pattern, activation of a legend, a change in a legend, activation of a sound, a change in a sound, activation of a physical movement, and a change in a physical movement.

4. The method recited in claim 1 wherein, in indicating, the human perceivable stimulus comprises a light emanating from a light source, the light source being turned on if the information is scrollable, and the light source being otherwise off.

5. The method recited in claim 1 wherein, in indicating, the human perceivable stimulus comprises a light emanating from a light source proximate to a scroll control element, the light source being turned on if the information is scrollable, and the light source being otherwise off.

6. The method recited in claim 1 wherein, in indicating, the human perceivable stimulus comprises a light emanating from a first light source proximate to a horizontal scroll control element, the first light source being turned on if the information is horizontally scrollable, and the first light source being otherwise off, and wherein the human perceivable stimulus further comprises a light emanating from a second light source proximate to a vertical scroll control element, the second light source being turned on if the information is vertically scrollable, and the second light source being otherwise off.

7. The method recited in claim 6 wherein, in indicating, the first light source, the second light source, the horizontal scroll control wheel, and the vertical scroll control wheel are elements of a pointing device.

8. A method comprising:
displaying information in a plurality of display windows of a computing device;
detecting a control signal from a user interface element from the group comprising a cursor position, a pointing device, a key, a button, a touch-sensitive screen, or a combination thereof, the control signal representing the selection of a specific display window; and
indicating whether the information in the specific display window is scrollable by activating a human perceivable stimulus.

9. The method recited in claim 8 wherein, in indicating, the human perceivable stimulus is from the group comprising a light, a sound, and a movement.

10. The method recited in claim 8 wherein, in indicating, the human perceivable stimulus comprises a light emanating from a light source, the light source being turned on if the information is scrollable, and the light source being otherwise off.

11. The method recited in claim 8 wherein, in indicating, the human perceivable stimulus comprises a light emanating from a light source proximate to a scroll control element, the light source being turned on if the information is scrollable, and the light source being otherwise off.

12. The method recited in claim 8 wherein, in indicating, the human perceivable stimulus comprises a light emanating from a first light source proximate to a horizontal scroll control wheel, the first light source being turned on if the information is horizontally scrollable, and the first light source being otherwise off, and wherein the human perceivable stimulus further comprises a light emanating from a second light source proximate to a vertical scroll control wheel, the second light source being turned on if the information is vertically scrollable, and the second light source being otherwise off.

13. The method recited in claim 12 wherein, in indicating, the first light source, the second light source, the horizontal scroll control wheel, and the vertical scroll control wheel are elements of a pointing device.

14. A computing device including a memory to store information and a computer program, and a user interface including a display, the computing device executing the computer program comprising the operations of:
displaying information in a window of the display; and
indicating whether the information is scrollable by activating a human perceivable stimulus.

15. The computing device recited in claim 14 wherein, in indicating, the computer program comprises the operation of turning on a light if the information is scrollable, and otherwise not turning on the light.

16. The computing device recited in claim 14 and further including a scroll control element and a light proximate to the scroll control element and wherein, in indicating, the computer program comprises the operation of turning on the light if the information is scrollable, and otherwise not turning on the light.

17. The computing device recited in claim 14 wherein the computing device comprises a horizontal scroll control element and a vertical scroll control element, and wherein, in indicating, the computer program comprises the operation of turning on a first light proximate to the horizontal scroll control element if the information is horizontally scrollable, and wherein the computer program further comprises the operation of turning on a second light proximate to the vertical scroll control element if the information is vertically scrollable.

18. The computing device recited in claim 14 wherein the computer program further comprises the operation of determining that a user of the computing device is focusing on a specific display window, and wherein, in indicating, the computer program comprises the operation of turning on a light if the information in the specific display window is scrollable, and otherwise not turning on the light.

19. The computing device recited in claim 18 wherein, in indicating, the computer program comprises the operation of turning on the light proximate to a scroll control element if the information in the specific display window is scrollable, and otherwise not turning on the light.

20. The computing device recited in claim 18 wherein, in determining, the computer program comprises the operation of detecting a control signal from a user interface element from the group comprising a cursor position, a pointing device, a key, a button, a touch-sensitive screen, or a combination thereof.

21. A computer network including a computing device having a user interface including a display, and a remote computing device, the computer network executing a computer program residing on the remote computing device comprising the operations of:
displaying information in a display window of the computing device; and
indicating whether the information is scrollable by activating a human perceivable stimulus.

22. The computer network recited in claim 21 wherein, in indicating, the computer program comprises the operation of turning on a light if the information is scrollable, and otherwise not turning on the light.

23. The computer network recited in claim 21 wherein the computing device further comprises a scroll control element, and wherein, in indicating, the computer program comprises the operation of turning on a light proximate to the scroll control element if the information is scrollable, and otherwise not turning on the light.

24. The computer network recited in claim 21 wherein the computing device comprises a horizontal scroll control element and a vertical scroll control element, and wherein, in indicating, the computer program comprises the operation of turning on a first light proximate to the horizontal scroll control element if the information is horizontally scrollable, and wherein the computer program further comprises the operation of turning on a second light proximate to the vertical scroll control element if the information is vertically scrollable.

25. An article comprising a machine-accessible medium having associated instructions, wherein the instructions, when accessed, result in a machine performing:
displaying information in a display window of a computing device; and
indicating whether the information is scrollable by activating a human perceivable stimulus.

26. The article recited in claim 25 wherein the computing device comprises a light, and wherein the instructions, when accessed by the machine, result in the machine performing the operation of turning on the light if the information is scrollable, and otherwise not turning on the light.

27. The article recited in claim 25 wherein the computing device further comprises a scroll control element and a light proximate to the scroll control element, and wherein the instructions, when accessed by the machine, result in the machine performing the operation of turning on the if the information is scrollable, and otherwise not turning on the light.

28. The article recited in claim 25 wherein the computing device comprises a horizontal scroll control element, a first light proximate to the horizontal scroll control element, a vertical scroll control element, and a second light proximate to the vertical scroll control element, and wherein, in indicating, the computer program comprises the operation of turning on the first light if the information is horizontally scrollable, and wherein the computer program further comprises the operation of turning on the second light if the information is vertically scrollable.
